(19) United States
(12) Patent Application Publication
(10) Pub. No.: US 2005/0117364 A1
(43) Pub. Date: Jun. 2, 2005

(54) Method and apparatus for projecting a turn signal indication

(76) Inventors: Mark Rennick, Marietta, GA (US); Patricia Rennick, Marietta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/970,876

(22) Filed: Oct. 22, 2004

Related U.S. Application Data
(60) Provisional application No. 60/514,728, filed on Oct. 27, 2003.

(51) Int. Cl. B60Q 1/26

(52) U.S. Cl. 362/540

(57) ABSTRACT

A vehicle turn signal projector for casting a predetermined image into an area adjacent to the vehicle is provided that comprises one or more light sources electrically coupled to a signal indication circuit associated with the vehicle, such as a left or right turn signal. The one or more light sources are configured to generate light energy within a predetermined space when the signal indication circuit is energized. The vehicle turn signal projector includes one or more apertures positioned beneath the one or more light sources, which are configured in a predetermined shape such that light energy passes though the one or more apertures from the one or more light sources. The light energy is cast into the area adjacent to the vehicle illuminating an image in accordance to the predetermined shape of the one or more apertures.

### CROSS-REFERENCE TO RELATED APPLICATION

This application claims priority to copending U.S. provisional application entitled, “Turn signal projector,” filed Oct. 27, 2003 and having Ser. No. 60/514,728, which is entirely incorporated herein by reference.

### FIELD OF THE INVENTION

This disclosure generally relates to automobile turn signals and, more particularly, to a method and apparatus for projecting a turn signal indicator.

### BACKGROUND OF THE INVENTION

It is not uncommon for traffic accidents to occur when a vehicle attempts to make a turn, and such turn is not noticed or otherwise previously communicated to drivers in other vehicles. Due to conventional mirrors on vehicles, many vehicles have one or more blind spots on either side such that the driver may not see a nearby vehicle. Likewise, drivers in the blind spot of the nearby vehicle may not necessarily receive prior indication of the intent of the driver of another vehicle to make a right or left turn. As a result, vehicles oftentimes crash during turning maneuvers, especially when the turning vehicle is towing a large trailer that may otherwise obscure conventional light signal indicators.

As a nonlimiting example of this situation, FIG. 1 is a diagram of a vehicle 12 towing a trailer 14 along a roadway. In this nonlimiting example, vehicle 15 is positioned nearby the rear of vehicle 12 but not behind the trailer 14 that is towed by vehicle 12. In the instance wherein vehicle 12 prepares to make a left turn (in this nonlimiting example), the driver in vehicle 15 may not necessarily be able to see conventional signal lamp indicators 17, 24 on the rear of vehicle 12 or perhaps on the rear of trailer 14, respectively. More specifically, indicator 17 on vehicle 12 may be obscured due to the forward corner of trailer 14. Thus, the line of sight 21 of the driver of vehicle 15 may be blocked by the forward corner of trailer 14 such that indicator 17 is not visible to the driver of vehicle 15. In similar fashion, turning signal indicator 24 may not be visible to the driver of vehicle 15 due to the forward position in respect to the indicator 24. As a result, the driver of vehicle 15 may not receive indication that the driver of vehicle 12 intends to make a left turn such that if the driver attempts to turn, a collision may result.

While the scenario described above in regard to FIG. 1 is a mere nonlimiting example, one of ordinary skill in the art would know that other similar situations commonly occur in traffic wherein the driver of one vehicle is not aware of the intent of a second driver to make a right or left turn. As a result, due to this failure to communicate the turning of one vehicle, a collision often results, thereby creating property damage and/or bodily injury.

The situation may be especially enhanced in situations wherein vehicle 12 is towing a trailer 14 that may be large or oversized due to the particular configuration of trailer 14. If trailer 14 is especially wide, it increases the likelihood that a driver of vehicle 15 may not necessarily see the turn signal indicators 17, 24 on vehicle 12 or trailer 14.

Thus, there is a heretofore unaddressed need to resolve the deficiencies and problems described above.

### BRIEF DESCRIPTION OF THE DRAWINGS

Many aspects of the invention can be better understood with reference to the following drawings. The components in the drawings are not necessarily to scale, emphasis instead being placed upon clearly illustrating the principals of the present invention. Moreover, in the drawings, like reference numerals designate corresponding parts throughout the several views.

FIG. 1 is a diagram of a first vehicle wherein the driver is unable to see the turn signal indications from a second vehicle towing a trailer.

FIG. 2 is a diagram of the vehicles of FIG. 1 such that the vehicle towing a trailer includes a turn signal projector to provide additional turn signal indication.

FIG. 3 is a diagram of the towing vehicle of FIGS. 1 and 2 depicting the turn signal projections to indicate lane changes or impending turns.

FIG. 4 is a diagram of a portion of the vehicle of FIGS. 1-3 depicting the turn signal projections on a road surface.

FIG. 5 is a diagram of the rearview mirror assembly of FIG. 2 depicting an illuminated turn signal indicator in the rear view mirror and the turn signal projection beam.

FIG. 6 is a diagram of the rearview mirror assembly of FIG. 8 depicting apertures for projected light.

FIG. 7 is a diagram of the bulb and lamp assembly of FIG. 6 for creating the projected turn signal as light is dispersed.

FIGS. 8A, 8B, and 8C is a diagram of multiple configurations of projections to provide various projected turn signal indications as depicted in FIG. 2.

FIG. 9 is a diagram of an alternative embodiment of the diagram of FIG. 2 wherein the projected turn signal is placed at the rear of the trailer unit.

FIG. 10 is an alternative embodiment of the turn signal projector of FIG. 2 depicting a receiver for detecting an obstacle within the turning path of the vehicle.

FIG. 11 is a diagram of a rear mirror similar to FIG. 5 but including an indicator for indicating the presence of a detected vehicle, as shown in FIG. 9.

FIG. 12 is a diagram of a circuit schematic which, as a nonlimiting example, may accomplish turn signal projection, as discussed above.

FIG. 13 is a diagram of an alternative embodiment circuit schematic wherein the turn signal projector may be configured to flash in accordance with signal function for turning or emergency flashers.

### DETAILED DESCRIPTION

In addition to the drawings discussed above, this description describes one or more embodiments as illustrated in the above-referenced drawings. However, there is no intent to limit this disclosure to a single embodiment or embodiments that are disclosed herein. On the contrary, the intent is to cover all alternatives, modifications, and equivalents included within the spirit and scope of this disclosure and as defined by the appended claims.

A vehicle turn signal projector for casting a predetermined image into an area adjacent to the vehicle is provided that comprises one or more light sources electrically coupled to a signal indication circuit associated with the vehicle, such as a left or right turn signal. The one or more light sources are configured to generate light energy within a predetermined space when the signal indication circuit is energized. The vehicle turn signal projector includes one or more apertures positioned beneath the one or more light sources, which are configured in a predetermined shape such that light energy passes though the one or more apertures from the one or more light sources. The light energy is cast into the area adjacent to the vehicle illuminating an image in accordance to the predetermined shape of the one or more apertures.

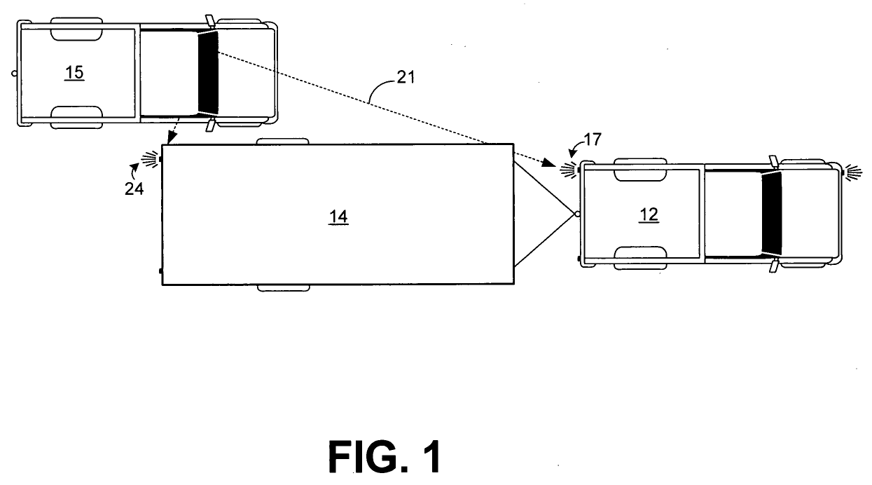

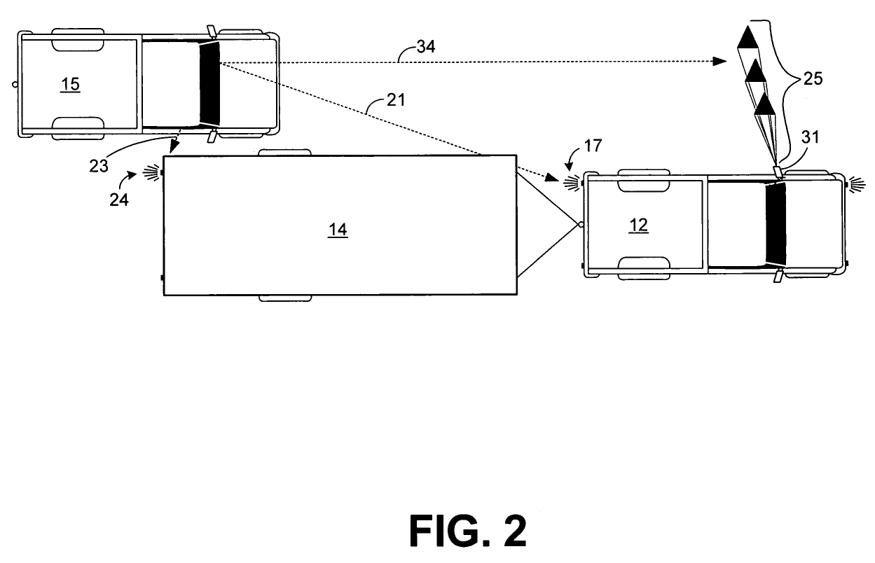

FIG. 2 is a diagram of the vehicles 12, 15 of FIG. 1 with vehicle 12 having additional projected turn signal indication 25 to alert the driver of vehicle 15 of an impending left turn. In this nonlimiting example, FIG. 1 illustrates a common occurrence wherein the driver of approaching vehicle 15 is unable to see the conventional turn signal indicators 17 and 24 mounted on vehicle 12 and turner 14, respectively. As indicated above, the driver of vehicle 15 has no direct line of sight to turn signal indicators 17 and 24 as evidenced by the line of sight indicators 21 and 23. More specifically, line of sight indicators 21 and 23 are broken by the corners of trailer 14, thereby representing the fact that the driver of vehicle 15 is unable to see the conventional turn signal indicators 17 and 24. Thus, as shown in FIG. 1, if the driver of vehicle 12 attempts to make a left turn, the driver of vehicle 15 may not receive information regarding the impending turn such that the driver of vehicle 15 collides with either vehicle 12 or trailer 14 when the turn is attempted. In such an instance, damage may result to vehicles 12 and 15, trailer 14, and any of the passengers in either vehicle.

To increase the safety of turning and/or lane changing in such instances, an image corresponding to the turn signal may be projected from vehicle 12 to the adjacent road surface, as shown in FIG. 2. In this nonlimiting example, the projected turn signal image 25 is shown as originating from the rearview mirror 31 of vehicle 12. However, one of ordinary skill in the art would know that the projected turn signal image 25 may originate from any point on vehicle 12 such that it is projected onto the adjacent road path, which may be in the path of vehicle 15.

In the nonlimiting example shown in FIG. 2, the projected turn signal image 25 represents arrows indicating the intention of the driver of vehicle 12 to make a left hand turn. However, one of ordinary skill in the art would know that one or more other images may also be projected to indicate turning or other driving operations, such as braking, emergencies, or other events. Nevertheless, as shown in FIG. 2, the projected image from vehicle 12 being cast into the adjacent driving lane communicates to the driver of vehicle 15 that vehicle 12 is preparing to make a lane change or left turn. Line of sight 34 represents the vantage viewpoint of the driver of vehicle 15 to clearly see the projected turn signal image 25 ahead of vehicle 15. Upon seeing the projected turn signal image 25, the driver of vehicle 15 may take evasive action so as to avoid collision with vehicle 12 and/or trailer 14 as the lane change or attempted turn is initiated.

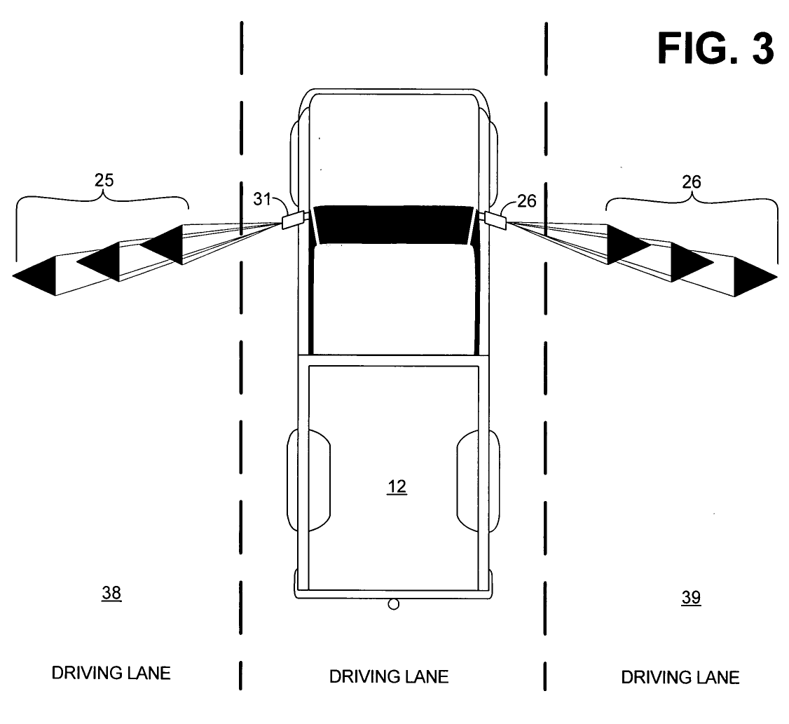

FIG. 3 is a diagram of vehicle 12 of FIG. 2 showing the projected turn signal image 25 in the left adjacent lane and a projected turn signal image 26 in a right adjacent lane. In this nonlimiting example, each of rear view mirrors 31 and 32 includes a projector for casting a predetermined image into the adjacent driving lanes 38 and 39.

The projected turn signal images 25 and 26 are represented in this nonlimiting example as displaced arrowheads into the respective driving lanes 38 and 39. However, one of ordinary skill in the art would know that a multitude of projected images may be placed upon the driving lanes 38 and 39 so as to indicate an intended turning action by vehicle 12. Consistent with any projected image is the notion that the projected turn signal images 25 and 26 should generally be configured such that approaching traffic in the adjacent driving lanes may otherwise detect and/or recognize the projected images as turning signal or emergency indications. Stated more specifically, the driver of vehicle 15 that may be positioned in driving lane 38 should recognize the projected turn signal image 25 as an indication that vehicle 12 is preparing to make a left turn or lane change. Similarly, a vehicle positioned in driving lane 39 should recognize the projected turn signal image 26 as an indication of an impending right turn by vehicle 12.

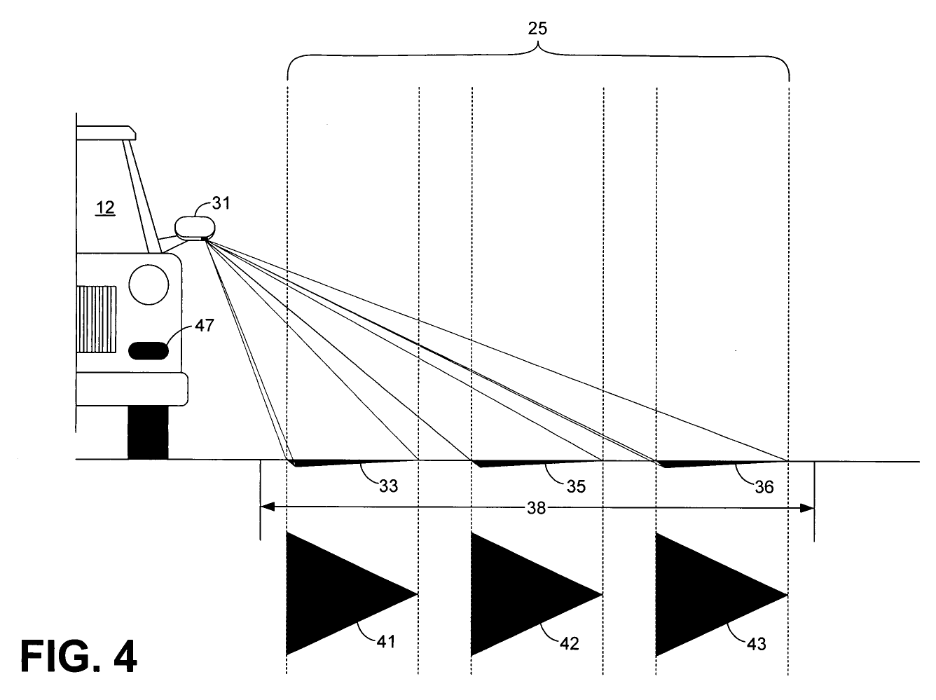

FIG. 4 is a diagram of vehicle 12 with the projections shown in adjacent driving lane 38, as depicted in FIG. 3. As discussed above, a nonlimiting example provides that the projected turn signal image 25 may be projected from a rearview mirror 31 such that a pattern of arrows or some other configuration is displayed upon the road surface in adjacent lane 38. In this nonlimiting example of FIG. 4, the projected image 25 includes arrows 33, 35, and 36, which are projected in an arrayed fashion across the width of adjacent driving lane 38. As shown in FIG. 4, the shape of projected images 33, 35, and 36, if viewed as a top view, correspond to arrows 41, 42, and 43. In this nonlimiting example, the arrows 33, 35, and 36 are displaced from each other so as to create a clear indication within driving lane 38 that the vehicle 12 is preparing to change lanes into driving lane 38 or otherwise make a left turn.

Vehicle 12 may also be configured such that if the emergency flashers are activated in vehicle 12, a different image may be projected into driving lane 38, as opposed to arrows 33, 35 and 36. One of ordinary skill in the art would know that a variety of images could be projected to communicate one or more meanings related to driving maneuvers.

In the nonlimiting example of FIG. 4, the projector is positioned within a portion of rearview mirror 31 so as to create an origin for projecting the turn signal image 25 into driving lane 38. In this nonlimiting example, the projected image is triggered or activated by the vehicle's left turn signal, which would otherwise activate front turn signal indicator 47. Thus, when the driver initiates the left turn signal in the vehicle, front turn signal indicator 47 and the projector within rearview mirror 31 activate to indicate the intention for making the left turn.

The turn signal projector may be integrally fashioned as a part of the rear view mirror 31 or may be an additional component that may be coupled or otherwise attached to the rear view mirror 31 as, for example, an aftermarket product to an existing automobile. In either case, the electric components powering the turn signal projector, as described above, may be electrically coupled to the turn signal circuitry for activation when a left or right turn is made or is signaled by the driver.

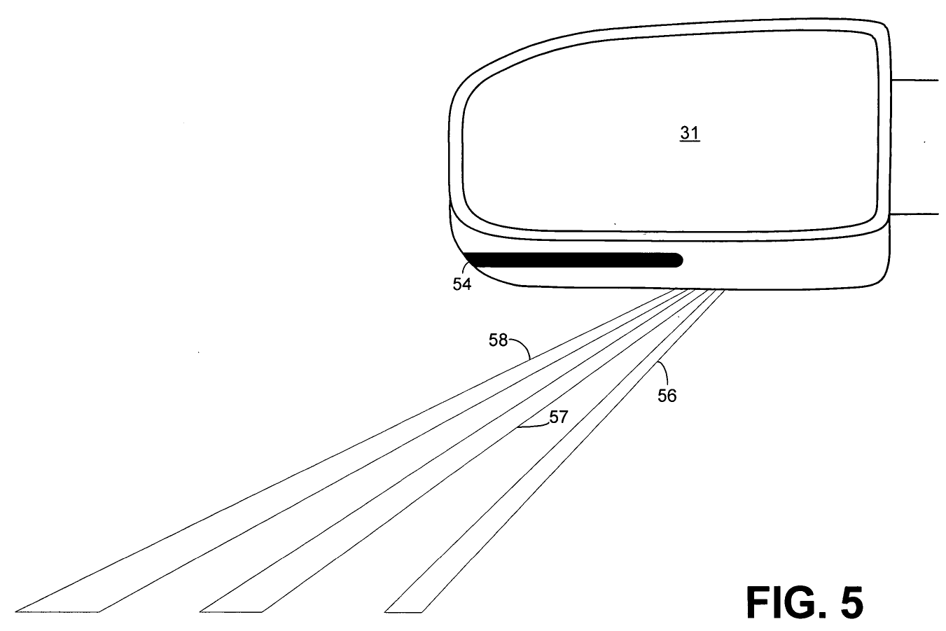

FIG. 5 is a diagram of rearview mirror 31 configured with the turn signal projector as described above. In this nonlimiting example, the turn signal projector is integrally fashioned as a part of the interior portion of the rearview mirror 31. However, one of ordinary skill in the art would also know that the turn signal projector may be configured as a separate component coupleable to the rearview mirror for projecting images onto adjacent driving lanes.

Yet, in this nonlimiting example of FIG. 5, the turn signal projector emits light or projected images, which are represented as image beam paths 56, 57, and 58 for producing arrows 33, 35, and 36, as shown in FIG. 4. In this nonlimiting example, the rearview mirror 31 includes an additional signal indicator bar 54 which may be illuminated by the same source as turn signal image 25 of FIG. 4. In this nonlimiting example, by configuring the emission of the projected turn signal image 25 from rearview mirror 31 along a bottom portion of the rearview mirror, a hazard is avoided as high powered light is not otherwise directed into the eyes of the driver of vehicle 12 or any other adjacent or nearby vehicle, such as vehicle 15.

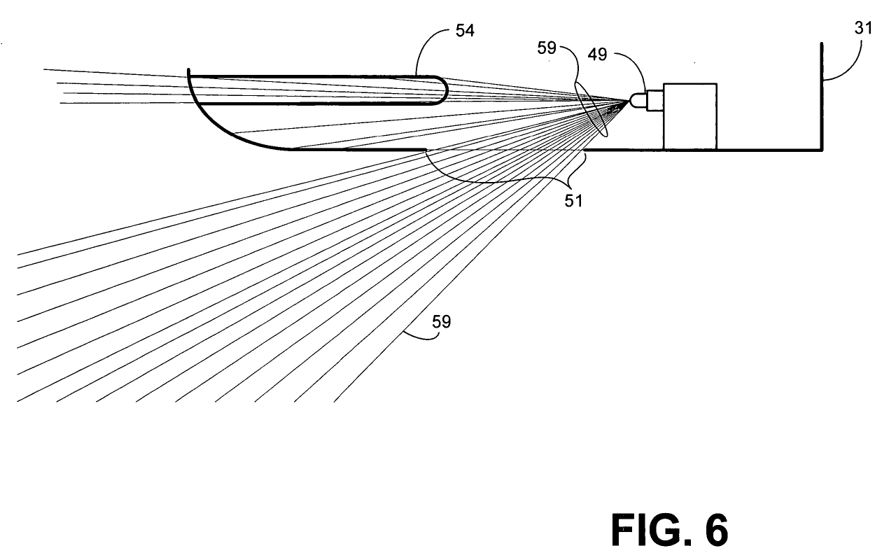

FIG. 6 is a partial diagram of the rearview mirror 31 of FIG. 5 depicting an interior portion of the rearview mirror that is configured for emitting the projected turn signal 25 of FIG. 4. In this nonlimiting example, one or more light sources 49 are configured to produce light energy 59 in one of the various patterns as described above. The bottom portion of rearview mirror 31 may be configured with one or more apertures 51 for allowing the emitted light 59 to exit through the rearview mirror 31 according to the desired pattern or mask, as described in more detail below. In this nonlimiting example, rearview mirror 31 includes the turn signal indicator bar 54, which allows light to pass from light source 49 that is further diffused as a signal indication.

As discussed in more detail below, aperture 51 may be configured according to a desired shape for producing a desired projected image shape. Plus, aperture 51 may or may not constitute a nonsealed opening, as one or more lenses or other translucent components may be positioned in aperture 51.

Incandescent, halogen, LED, laser, xenon lamps, or bulbs may be used as a light source 49 for the turn signal projector of this disclosure. Furthermore, this disclosure is not intended to be limited to a specific or a particular type of lighting, as one of ordinary skill in the art may know. Additional types of illuminating devices may operate as the light source 49 for creating the projected turn signal 25 of this disclosure.

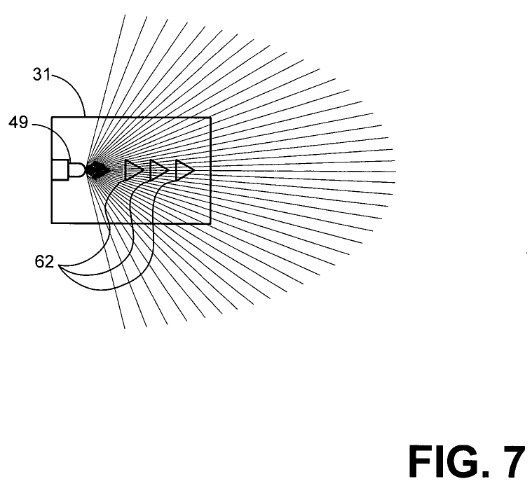

FIG. 7 is a diagram of the rearview mirror 31 with light source 49 displayed and a projection mask 62 that forms the projected turn signal image 25 on the adjacent driving lane 38. In this nonlimiting example, light source 49 illuminates and casts light within the internal cavity of rearview mirror 31 as depicted in FIG. 7. (The illumination lines are actually shown beyond the boundary of rearview mirror 31, but one of ordinary skill in the art would know that the light would be contained within the rearview mirror 31. The light is shown outside of rearview mirror 31 to demonstrate that a single light source may illuminate the interior cavity of the rearview mirror 31 containing the turn signal projector.)

Mask 62, in this nonlimiting example, is comprised of three arrows. As discussed in more detail below, light energy emitted from light source 49 passes through apertures 62 to create projected image 25. The apertures 62 may be sized differently so that the images cast on the road surface 38 are similarly sized. One of ordinary skill would know that altering the size of apertures 62 would adjust the size of images 33, 35, and 36.

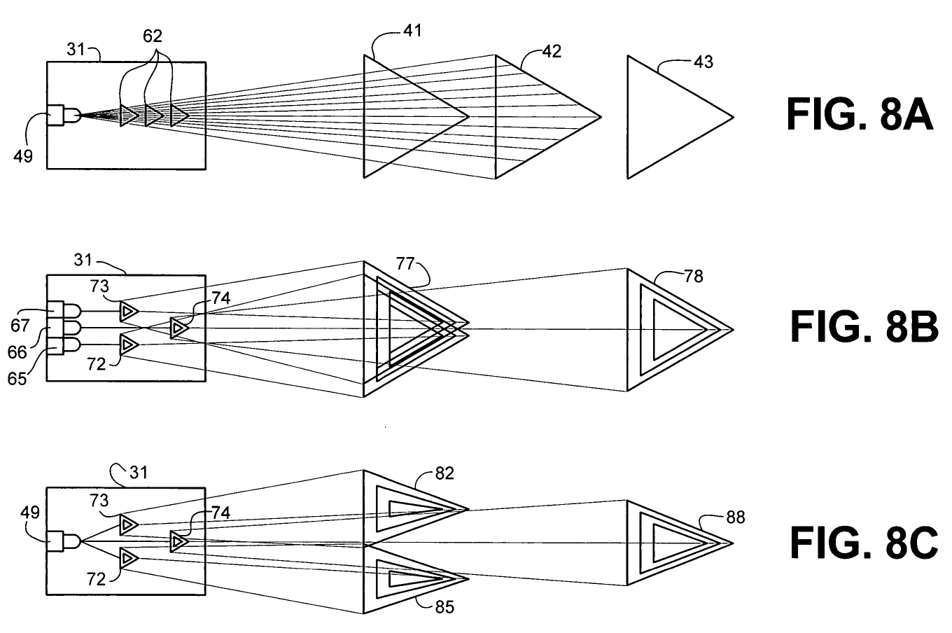

FIGS. 8A, 8B, and 8C represent at least three lighting configurations for creating defined image patterns for projection onto the road surface of adjacent driving lane 38. In the nonlimiting example of FIG. 8A, light source 49 may be configured, as described above, within rearview mirror 31 or illuminate the interior cavity of rearview mirror 31 such that emitted light passes through mask 62 that is fashioned as three triangular arrows. The result is the projected turn signal image 25 which comprises arrows 41, 42, and 43, as described above. In this nonlimiting example, light source 49 illuminates the internal space of rearview mirror 31 such that light passes through the unmasked portions along the bottom side of rearview mirror 31 for creating the turn signal image 25, which is fashioned as three arrows in this nonlimiting example, as shown in FIG. 8A.

In FIG. 8B, rearview mirror 31 is fashioned in this nonlimiting example with three light sources 65, 66, and 67. In this nonlimiting example, refracting lenses 72, 73, and 74 are implemented so as to direct the emitted light from light sources 65, 66, and 67 for creating the pattern as shown in FIG. 8B. In this nonlimiting example, refracted lenses 72, 73, and 74 create a combined image 77 which may be of a greater intensity than a nonrefracted image, as described above in FIG. 8A. The projected image 77 is created in this nonlimiting example by refracted lenses 72, 73 which are configured for focusing the light emitted from light sources 65, 66, 67 in this fashion. Refracting lens 74 likewise creates image 78 as an image of ordinary or regular brightness and intensity. Using the multiple light sources 65, 66, 67 creates angles that cause refracting lenses 72, 73 to essentially overlay the light passing through the refracted lenses 72 and 73 for creating combined image 77.

In FIG. 8C, light source 49 is implemented within the rearview mirror 31 which causes light to pass through reflecting lenses 72, 73, and 74. Projected images 82, 85, and 88 are cast upon driving lane 38 in the pattern as shown in FIG. 8C. In this nonlimiting example, a single light source is used which causes the three projected images 82, 85, and 88 to be created through the refracting lenses, as opposed to the overlaid image 77 of FIG. 8B.

As discussed above, the pattern of apertures, as shown in FIGS. 8A-8C, may be configured in a variety of configurations to achieve a variety of projected images. Plus, various focusing devices may be used to focus the emitted light energy to increase the brightness of the projected image.

The pattern shown in FIGS. 8A, 8B, and 8C may be created, as described above, by a variety of sources. As an additional nonlimiting example, the rearview mirror may include a laser that is configured to electronically draw the desired image as shown in FIGS. 8A, 8B, or 8C, or another image onto the adjacent driving lane. Moreover, the shape of the image on the road surface may be, as additional nonlimiting examples, a dart, arrow, or any other shape recognizable by other drivers as a clear intent to signal a turn, lane change, or emergency situation.

Returning to FIG. 6, light source 49 may emit light in a radius from the lamp itself, and this light may be defined in a shape by the masked area 51 to create the visible turn signal image 25 as a function of the design of the rearview mirror housing 31. Thus, in this way, light emitted from light source 49 may be used to create both a visible turn indication through diffusing lens 54 and to project outwardly from rearview mirror 31 for creating the projected turn signal image 25.

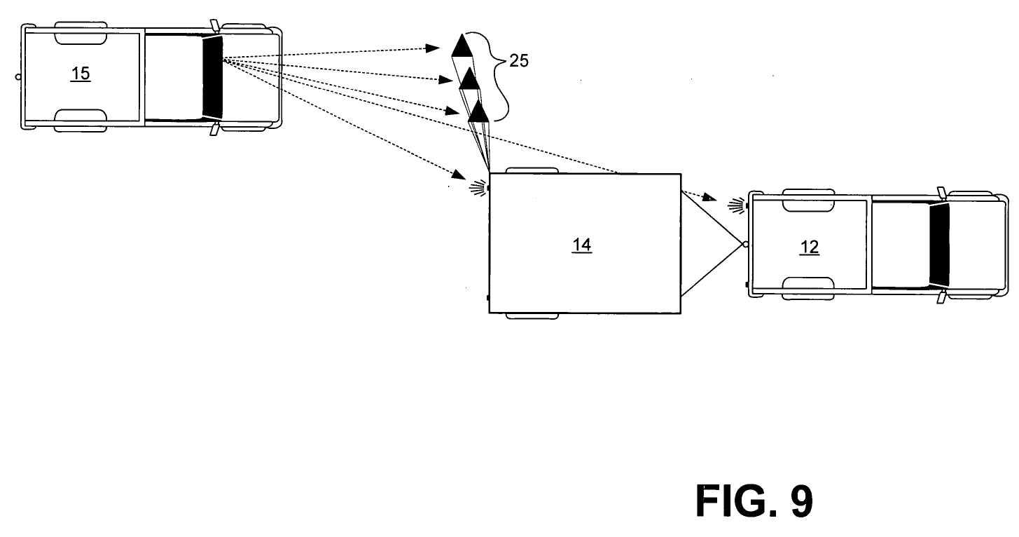

As an alternate embodiment to the disclosure above, the turn signal projector may be positioned upon the trailer 14. In this nonlimiting example, the projected turn signal image 25 may be cast upon the adjacent lane 38 proximate to the rear area of trailer 14 for vehicles to the rear of vehicle 12 and/or trailer 14. Placing the projected turn signal image 25 as shown in FIG. 9 alerts the driver of vehicle 15 not to approach alongside vehicle 12 due to the impending turn or lane change. Thus, as described above, the projected turn signal indication may be placed at one or more points for projecting the intent for turning into the adjacent driving lane 38.

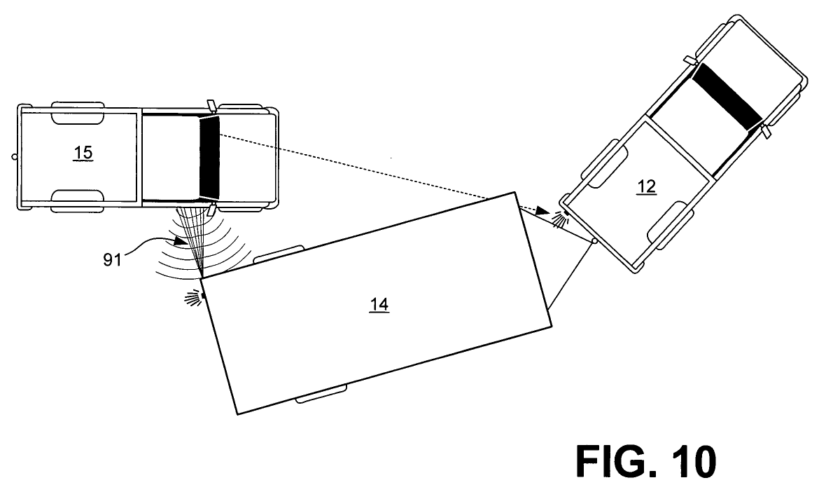

As an alternative embodiment, the image projected from the rearview mirror 31 or from trailer 14 may also be used as a sensor to alert the driver of vehicle 12 that another vehicle or obstacle is adjacently positioned. As a nonlimiting example, FIG. 10 depicts the placement of the turn signal projector near a rear point of trailer 14. In this nonlimiting example, trailer 14 substantially obscures the rear view of the driver of vehicle 15 from detecting a rear turn signal on vehicle 12 or on trailer 14. As also shown in this nonlimiting example, vehicle 12 and trailer 14 are shown making a left turn in front of vehicle 15. Thus, as shown in this nonlimiting example, the image may be projected 91 into the adjacent driving lane; however, in this instance, the projected image strikes a side portion of vehicle 15. A portion of the projected image 91 is reflected from vehicle 15 and is cast back upon trailer 14. A sensor positioned on trailer 14 detects reflected light image 91 and communicates such detection to a processor, which alerts the driver of the positioned obstacle and potential collision possibility.

As a nonlimiting example, the sensor that detects reflected light may be a photocell configured with any of the lamp types described above to detect light in a visible or invisible spectrum reflected from the nearby vehicle 15 that has moved into the position that puts all vehicles at risk. Thus, upon detecting the reflected light emitted from the turn signal projector on trailer 14, an alert may be provided to the driver of vehicle 12 informing the driver that another vehicle or obstacle is located in the space that vehicle 12 and trailer 14 are attempting to occupy.

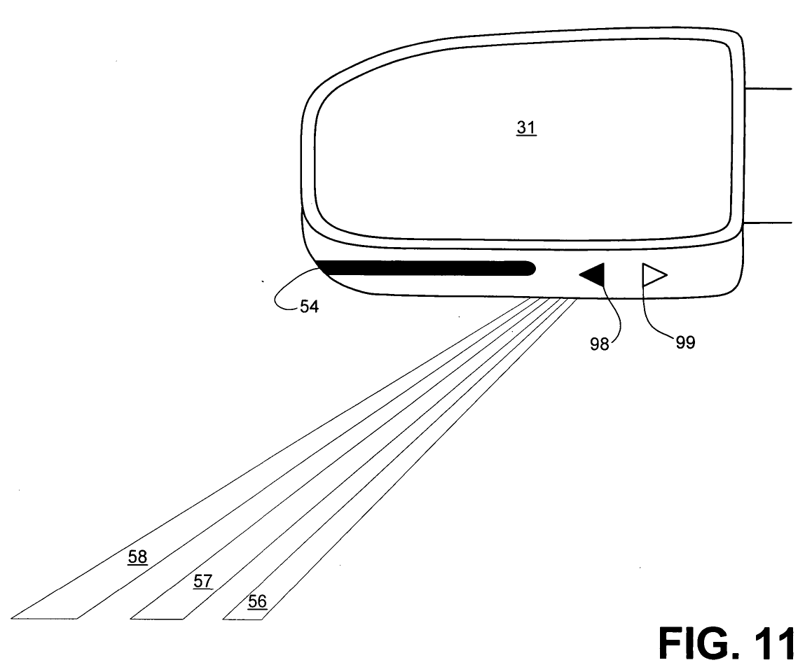

The turn signal projector in each of the instances described above may be activated when the driver of vehicle 12 activates a turn signal. For the nonlimiting example of FIG. 11, upon detecting the presence of vehicle 15, an audible or visible alert signal may be provided to warn the driver of vehicle 12 of the hazard. More specifically, a warning light in the instrumentation panel of vehicle 12 or other visual or audio means may be implemented to alert the driver of the impending hazard.

FIG. 11 is a diagram of rearview mirror 31 with an additional indicator for alerting the driver of an obstacle detected on the left or right side of vehicle 12. Thus, in the nonlimiting example depicted in FIG. 10, upon detecting the presence of vehicle 15, the turn signal projector may communicate the visual alert to indicator 98. Rearview mirror 31 of FIG. 11 depicts a left turn situation wherein the diffusing lens 54 is illuminated, showing the left turn indication, as well as the light projection beams 56, 57, and 58, which cast an image onto adjacent driving lane 38. Therefore, by adding indicators 98 and 99, the driver may be alerted to the detection of another vehicle in addition to the attempts to warn approaching vehicles by the projected turn signal image 25 and diffusing lens 54. In this way, the use of data displayed on the outside mirror by indicators 98 and 99 provide the driver of vehicle 12 with an advance notice of an obstacle in the driver's blind spot so that a collision can potentially be avoided.

As described above, the turn signal projector as disclosed herein may be configured as an add-on system to an existing mirror or as an integrated part of the mirror assembly 31. One of ordinary skill in the art would be aware of various configurations for new and used vehicles consistent with the disclosure herein.

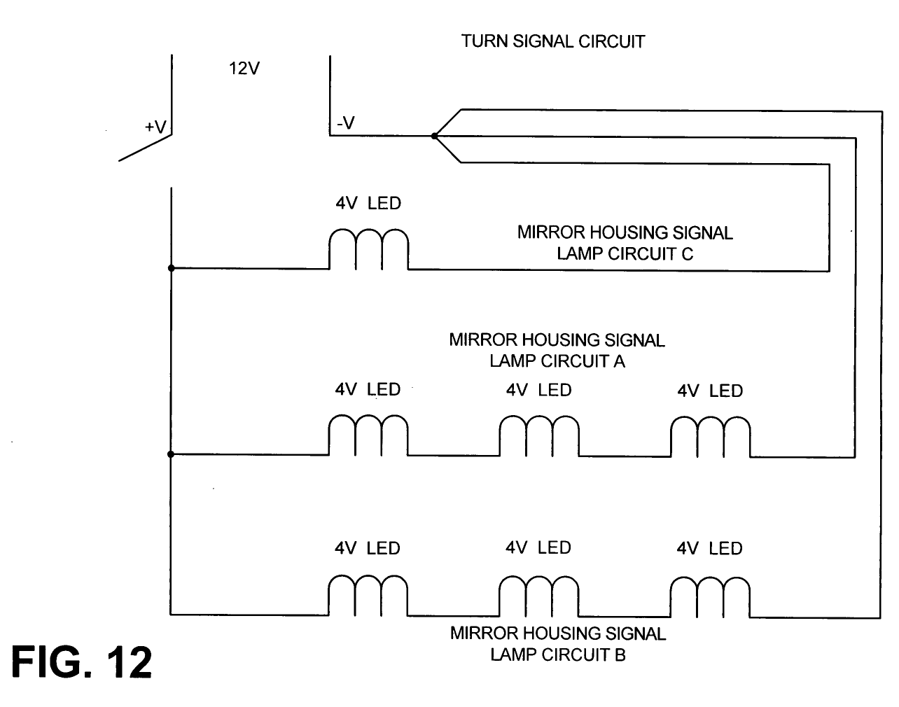

FIG. 12 is a diagram of at least one of a number of electrical circuits that may be implemented to accomplish turn signal projection, as disclosed herein. As illustrated in FIG. 12, a plurality of lighting sources may be used to increase the overall light output of the projected turn signal image 25. In the turn signal circuit of FIG. 12, one or more groupings of LEDs may be placed in parallel so as to create an increased number of lighting circuits that result in a higher illuminated output. The mirror housing signal lamp circuits A, B, and C may be positioned at different points within the rearview mirror 31 as described above for illuminating the diffusing lens 54, as well as any mask or refracting lens for creating the projected turn signal image 25. Moreover, by including a greater number of light sources, the failure of one or more light sources will not hinder the continued operation of the turn signal projector from producing the projected image 25.

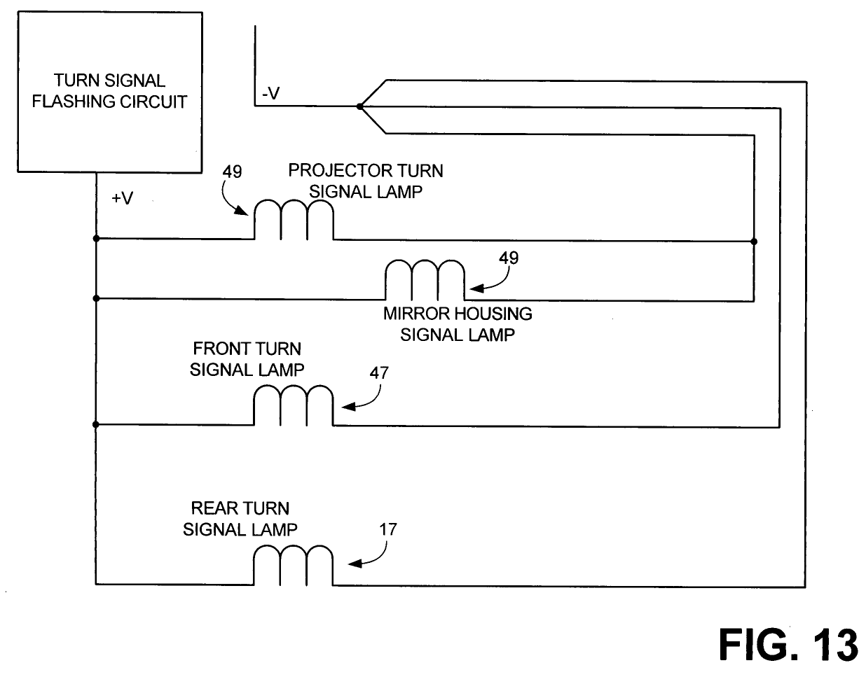

FIG. 13 depicts the turn signal projector lamp circuit placed in parallel with the front and rear turn signal lamp circuits of vehicle 12, as well as the mirror housing lamp circuit for illuminating the diffusing lens 54. The circuit diagram of FIG. 13 includes placing the light source in parallel so that the actuation of a turn signal switch (i.e., for a left turn) energizes each of the signal lamps to illuminate the front and rear turn signal indicators as well as the projector lamp and any light sources utilized for the diffusing lens 54. The turn signal projector lamp, as shown in FIG. 13, may comprise one or more light sources as described above for increasing the light output, thereby resulting in a higher visible image 25. By increasing the number of turn signal projector light sources, as disclosed herein, other drivers and pedestrians may view the projected light image 25 during daylight hours or during other times irrespective of road surface conditions, weather conditions, or any other variables that may diminish visibility.

It should be emphasized that the above-described embodiments and nonlimiting examples are merely possible examples of implementations, merely set forth for a clear understanding of the principles disclosed herein. Many variations and modifications may be made to the above-described embodiment(s) and nonlimiting examples without departing substantially from the spirit and principles disclosed herein. All such modifications and variations are intended to be included herein within the scope of this disclosure and protected by the following claims.

1. A vehicle turn signal projector for casting a predetermined image into an area adjacent to the vehicle, comprising:
one or more light sources electrically coupled to a signal indication circuit associated with the vehicle, wherein the one or more light sources generate light energy within a predetermined space when the signal indication circuit is energized; and
one or more apertures positioned beneath the one or more light sources configured in a predetermined shape such that light energy passes though the one or more apertures from the one or more light sources and casts an illuminated image into the area adjacent to the vehicle in accordance with the predetermined shape of the one or more apertures.

2. The vehicle turn signal projector of claim 1, wherein the one or more light sources and the one or more apertures are positioned within a rear view mirror assembly on the vehicle.

3. The vehicle turn signal projector of claim 2, wherein the one or more apertures are positioned on an underside portion of the rear view mirror so that light energy passes downward to the area adjacent to the vehicle.

4. The vehicle turn signal projector of claim 1, wherein each of the one or more apertures contain a lens to focus light energy generated by the one or more light sources.

5. The vehicle turn signal projector of claim 1, wherein each of the one or more apertures constitutes a mask configured to allow light energy generated by the one or more light sources to pass in a shape conforming to the mask.

6. The vehicle turn signal projector of claim 1, wherein the illuminated image comprises a plurality of arrows.

7. The vehicle turn signal projector of claim 1, wherein the light source comprises a plurality of light emitting diodes.

8. The vehicle turn signal projector of claim 1, wherein the light source comprises one or more sources selected from the following: incandescent bulbs; halogen bulbs; and laser.

9. The vehicle turn signal projector of claim 1, wherein the one or more light sources are electrically coupled to the signal indication circuit in parallel to one or more turn signal lamps.

10. The vehicle turn signal projector of claim 1, wherein the vehicle signal indicator is a unit coupleable to the vehicle.

11. A method for a vehicle to signal an impending turn or lane change to other vehicles and pedestrians, comprising the steps of:
activating a turn signal indication circuit;
illuminating a light source positioned within a rear view mirror assembly and coupled to the turn signal indication circuit;
passing light energy generated by the light source through a mask having one or more translucent openings and positioned on a bottom portion of the rear view mirror that is configured according to a predetermined shape; and
illuminating an adjacent road surface area with the light energy generated by the light source and passed through the one or more translucent openings so that an illuminated image corresponding to a turn signal indication is cast upon to the adjacent road surface area in accordance with the predetermined shape of the one or more translucent openings in the mask.

12. The method of claim 111, further comprising the step of:
illuminating a diffusing lens positioned on an exterior portion of the rear view mirror assembly with light energy from the light source so as to indicate an impending turn or emergency condition.

13. The method of claim 11, further comprising the step of:
refracting light energy by one or more lenses positioned in the one or more translucent openings so as to focus the light energy into a predetermined shape on the adjacent road surface area.

14. The method of claim 13, wherein light energy passes through two or more refracting lenses that focus the refracted light energy into a combined predetermined shape on the adjacent road surface area has an enhanced luminance value.

15. The method of claim 11, wherein the predetermined shape comprises a plurality of arrow-shaped images.

16. The method of claim 11, wherein the adjacent road surface area is an adjacent driving lane.

17. The method of claim 11, wherein the light source flashes in unison with the other activated turn signals on the vehicle.

18. A vehicle turn signal projector for casting a predetermined image into an area adjacent to the vehicle, comprising:
one or more light sources electrically coupled to a signal indication circuit associated with the vehicle, wherein the one or more light sources generate light energy within a predetermined space when the signal indication circuit is energized;
one or more apertures configured in a predetermined shape such that light energy passes though the one or more apertures from the one or more light sources and casts an illuminated image into the area adjacent to the vehicle in accordance to the predetermined shape of the one or more apertures;
one or more sensors configured to detect light energy reflected from an object within the area adjacent to the vehicle in which the illuminated image is cast; and
an alerting device coupled to the one or more sensors configured to indicate the detected presence of the object within the area adjacent to the vehicle.

19. The vehicle turn signal projector of claim 18, wherein the alerting device is positioned in a rear view mirror of the vehicle.

20. The vehicle turn signal projector of claim 18, further comprising:
a processor coupled to the sensor configured to receive a signal from the sensor and determine whether the signal indicates the presence of an object within the area adjacent to the vehicle, wherein the processor communicates a signal to the alerting device to activate.

21. A rear view mirror assembly on a vehicle, comprising:
a mirror coupled to a housing so that the mirror is adjustable;
a light source positioned in the rear view mirror assembly electrically coupled to a turn signal circuit in the vehicle so that the light source emits light energy when the turn signal circuit is energized; and
one or more apertures positioned on the underside of the rear view mirror assembly configured to direct light energy emitted from the light source into a driving lane adjacent to the vehicle in to a predetermined shape in accordance with the one or more apertures.

22. The rear view mirror of claim 21, further comprising:
a diffusing lens in the rear view mirror housing configured to direct light energy emitted from the light source to create a point of illumination as an indication to other drivers.

23. The rear view mirror of claim 21, wherein the light source includes a plurality of LEDS within the rear view mirror.

24. The rear view mirror of claim 21, wherein the one or more apertures contain a refracting device configured to focus light energy for increasing a brightness level of an image cast into the adjacent driving lane.
